(19) United States
(12) Patent Application Publication
(10) Pub. No.: US 2025/0276627 A1
(43) Pub. Date: Sep. 4, 2025

(54) SEAT WITH REMOVABLE HEADREST

(71) Applicant: Rivian IP Holdings, LLC, Irvine, CA (US)

(72) Inventors: Stephanie Catherine RADION, Mission Viejo, CA (US); Michael MEDORO, Rancho Santa Margarita, CA (US); Rohan DARAN, Newport Beach, CA (US); Shreyas SANSUDDI, Long Beach, CA (US); Firoz DIVAN NAIK, Lake Forest, CA (US); Peyman DELPARASTAN, Belmont, CA (US); Thomas Flashe YOUNG, Costa Mesa, CA (US); Luis Miguel de Matos ISIDORO, Irvine, CA (US); Harshad ZAMBARE, Irvine, CA (US)

(21) Appl. No.: 19/063,160

(22) Filed: Feb. 25, 2025

Related U.S. Application Data
(60) Provisional application No. 63/560,593, filed on Mar. 1, 2024.

(51) Int. Cl. B60N 2/882; B60N 2/90

(52) U.S. Cl. CPC B60N 2/882; B60N 2/929

(57) ABSTRACT

A seat of a vehicle can include a removable headrest with a locking and release mechanism and a trimmed bun region which engages with armatures of the seat that extend from a seat back. The user can remove the headrest by pressing a release button on a side of the headrest. The user can then lift up to slide the headrest from the armatures. The headrest can then be stored within the vehicle interior (e.g., glovebox, back on the seat, on the seat cushion) or frunk for safe storage. One or more sensors (e.g., interior camera) can be operated to ensure that the headrest is removed from the seat prior to folding operation. One or more sensors (e.g., interior camera) can be operated to ensure that the headrest is installed onto the seat prior to one or more operations of the vehicle.

### CROSS REFERENCE TO RELATED APPLICATIONS

This application claims the benefit of priority to U.S. Provisional Patent Application No. 63/560,593, entitled, “SEAT WITH REMOVABLE HEADREST”, filed on Mar. 1, 2024, the disclosure of which is hereby incorporated herein in its entirety.

### INTRODUCTION

The present description relates generally to vehicles. More particularly, the present disclosure relates to management systems for a seat with a removable headrest. Vehicles are often provided with seats that can be adjusted with various positions and orientations to accommodate the preferences of a variety of users.

### SUMMARY

Embodiments of the present disclosure are directed toward a seat of a vehicle that can include a removable headrest with a locking and release mechanism and a trimmed bun region which engages with armatures of the seat that extend from a seat back. The user can remove the headrest by pressing a release button on a side of the headrest. The user can then lift up to slide the headrest from the armatures. The headrest can then be stored within the vehicle interior (e.g., glovebox, back on the seat, on the seat cushion) or frunk for safe storage. One or more sensors (e.g., interior camera) can be operated to ensure that the headrest is removed from the seat prior to folding operation. One or more sensors (e.g., interior camera) can be operated to ensure that the headrest is installed onto the seat prior to one or more operations of the vehicle.

In accordance with aspects of the subject technology, an apparatus is provided that includes a seat back; an armature extending from a portion of the seat back and comprising a striker; and a headrest configured to receive a portion of the armature. The headrest includes a latch configured to releasably engage the striker and a release button configured to actuate the latch to release the striker.

The latch may be configured to rotate within the headrest to transition between a locked configuration and an unlocked configuration. The latch may be biased to the unlocked configuration. The headrest may further include a lever configured to maintain the latch in the locked configuration while the lever is in a first configuration, wherein the release button is configured to actuate the latch by transitioning the lever to a second configuration, in which the lever is configured to allow the latch to transition to the unlocked configuration. The release button may define a portion of an outer periphery of the headrest. The portion of the armature may be a first portion of the armature, wherein the seat back is configured to receive a second portion of the armature. A portion of the latch may extend from the headrest to within a portion of the seat back to releasably engage the striker.

In accordance with aspects of the subject technology, a method is provided that includes: receiving a transition signal comprising an instruction to transition a seat from an extended configuration to a folded configuration; and in response to receiving the transition signal: detecting a configuration of a headrest of the seat; in accordance with a determination that the headrest is attached to the seat, outputting a notification; and in accordance with a determination that the headrest is detached from the seat, transitioning the seat from the extended configuration to the folded configuration.

The method may further include, after outputting the notification: detecting the configuration of the headrest of the seat; in accordance with the determination that the headrest is attached to the seat, maintaining output of the notification; and in accordance with the determination that the headrest is detached from the seat, ceasing output of the notification and transitioning the seat from the extended configuration to the folded configuration.

The method may further include, in response to receiving the transition signal and in accordance with the determination that the headrest is attached to the seat, forgoing transition of the seat from the extended configuration to the folded configuration. Detecting the configuration of the headrest of the seat may include operating a camera to optically detect whether the headrest is attached to the seat. The notification may include an instruction to a user to detach the headrest from the seat. The transition signal may be generated in response to a user input at an input device of the seat.

In accordance with aspects of the subject technology, a method is provided that includes: receiving a start signal comprising an instruction to perform an operation of a vehicle; and in response to receiving the start signal: detecting a configuration of a headrest of a seat of the vehicle; in accordance with a determination that the headrest is attached to the seat, performing the operation of the vehicle; and in accordance with a determination that the headrest is detached from the seat, forgoing performance of the operation of the vehicle.

The method may further include, in response to receiving the start signal and in accordance with the determination that the headrest is detached from the seat, outputting a notification. The method may further include: after outputting the notification and while forgoing performance of the operation of the vehicle, receiving an override signal from a user; and in response to receiving the override signal from the user, performing the operation. The override signal may be generated in response to a user input at an input device of the vehicle. The notification may include an instruction to a user to attach the headrest to the seat. The operation may include operating a motor of the vehicle. Detecting the configuration of the headrest of the seat may include operating a camera to optically detect whether the headrest is attached to the seat.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic perspective side view of an example implementation of a vehicle having a dashboard in accordance with one or more implementations.

FIG. 2 illustrates a perspective view of an example implementation of a seat in accordance with one or more implementations.

FIG. 3 illustrates a perspective view of an example implementation of a portion of a seat in accordance with one or more implementations.

FIG. 4 illustrates a side view of an example implementation of a seat with a removable headrest in accordance with one or more implementations.

FIG. 5 illustrates a perspective view of an example implementation of a headrest in accordance with one or more implementations.

FIG. 6 illustrates a perspective view of an example implementation of a dashboard for a vehicle having containers in a closed configuration in accordance with one or more implementations.

FIG. 7 illustrates a perspective view of an example implementation of the dashboard of FIG. 2 having containers in an open configuration in accordance with one or more implementations.

FIG. 8 illustrates a side view of an example implementation of a seat in a folded configuration and a dashboard in accordance with one or more implementations.

FIG. 9 illustrates a side view of an example implementation of a seat in a folded configuration and a dashboard in accordance with one or more implementations.

FIG. 10 illustrates a schematic view of an example implementation of a locking assembly for a headrest of a seat with a latch in a locked configuration in accordance with one or more implementations.

FIG. 11 illustrates a schematic view of an example implementation of the locking assembly of FIG. 10 seat with a button in an actuated configuration in accordance with one or more implementations.

FIG. 12 illustrates a schematic view of an example implementation of the locking assembly of FIGS. 10 and 11 with the latch in an unlocked configuration in accordance with one or more implementations.

FIG. 13 illustrates a schematic view of an example implementation of a locking assembly for a headrest of a seat with a latch in a locked configuration in accordance with one or more implementations.

FIG. 14 illustrates a schematic view of an example implementation of the locking assembly of FIG. 13 seat with a button in an actuated configuration and the latch in an unlocked configuration in accordance with one or more implementations.

FIG. 15 illustrates a schematic view of an example implementation of the locking assembly of FIGS. 13 and 14 with the headrest removed from the seat in accordance with one or more implementations.

FIG. 16 illustrates a schematic view of an example implementation of a locking assembly for a headrest of a seat with a latch in a locked configuration in accordance with one or more implementations.

FIG. 17 illustrates a schematic view of an example implementation of the locking assembly of FIG. 16 seat with a button in an actuated configuration and the latch in an unlocked configuration in accordance with one or more implementations.

FIG. 18 illustrates a schematic view of an example implementation of the locking assembly of FIGS. 16 and 17 with the headrest removed from the seat in accordance with one or more implementations.

FIG. 19 illustrates a flow diagram of an example process for managing a locking system based on one or more detections in accordance with one or more implementations of the subject technology.

FIG. 20 illustrates a flow diagram of an example process for managing a locking system based on one or more detections in accordance with one or more implementations of the subject technology.

FIG. 21 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Embodiments of the present disclosure are directed toward a management system for one or more seats with a removable headrest. Apparatuses, such as vehicles, buildings, and/or other enclosed and/or indoor spaces are often provided with seats. Such seats can support one or more users.

Some seats can provide a capability to at least partially fold. However, with some seats (e.g., front seats), the dashboard and other features (e.g., steering wheel) of the vehicle provide insufficient clearance between the and the headrests of the folding seats during the folding motion. Where headrests are removable, the seat can be provided with additional clearance. However, the removable portion of some headrests are excessively large, which the requires a larger space for storage thereof until it is returned to the seat.

Embodiments of the present disclosure include a headrest of a seat with a locking and release mechanism and a trimmed bun region which engages with armatures of the seat that extend from a seat back. The user can remove the headrest by pressing a release button on a side of the headrest. The user can then lift up to slide the headrest from the armatures. The headrest can then be stored within the vehicle interior (e.g., glovebox, back on the seat, on the seat cushion) or frunk for safe storage. One or more sensors (e.g., interior camera) can be operated to ensure that the headrest is removed from the seat prior to folding operation. This ensures that the seat does not clash with the dashboard, steering wheel, or other features of the vehicle. One or more sensors (e.g., interior camera) can be operated to ensure that the headrest is installed onto the seat prior to one or more operations of the vehicle.

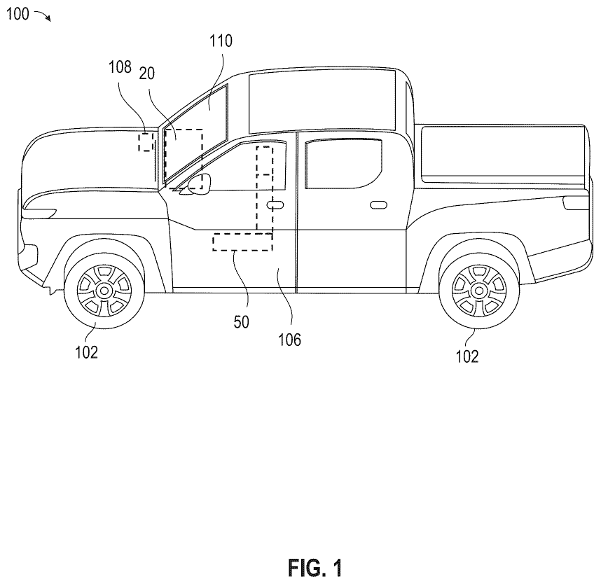

FIG. 1 is a diagram illustrating an example implementation of an apparatus as described herein. In the example of FIG. 1, the apparatus is a moveable apparatus implemented as a vehicle 100. In one or more implementations, the vehicle 100 may be implemented as an electric vehicle and may include one or more batteries for powering the vehicle and/or one or more systems and/or components of the vehicle.

For example, in one or more implementations, the vehicle 100 may be an electric vehicle having one or more electric motors that drive the wheels 102 of the vehicle using electric power from the battery. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1, the vehicle 100 is implemented as a truck (e.g., a pickup truck) having a dashboard 20 within a passenger compartment 110 of the vehicle 100. The vehicle 100 can further include one or more seats 50 within the passenger compartment 110. While only one seat 50 is illustrated in FIG. one, it will be understood that any number of seats 50 can be provided within the passenger compartment 110 of the vehicle 100. For example, the seats 50 can be provided in one or more rows within the passenger compartment 110. At least some of the seats 50 can have one or more features in common while being positioned at different locations within the passenger compartment 110. One or more of the seats 50 can be positioned near a corresponding one of the doors 106 of the vehicle 100. Accordingly, the doors 106 can provide access to the passenger compartment 110 and one or more of the seats. Anyone or more of the seats 50 can be provided with the features described herein.

The one or more seats 50 can be movable with respect to the dashboard 20 and/or one or more other structures within the passenger compartment 110. As shown, the vehicle 100 may also include processing circuitry 108 (e.g., one or more processors, memory, and/or communications circuitry). The processing circuitry 108 may be communicatively coupled to the seats 50 and/or one or more other components of the vehicle 100, for control, by the processing circuitry 108, thereof.

As examples, the processing circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., seats 50, displays, cameras, motion sensors, proximity sensors, etc.). The processor(s) of the processing circuitry 108 may execute instructions stored in the memory of the processing circuitry 108, such as to execute hardware, firmware, and/or software processes in order to perform the processes of the subject disclosure.

The example of FIG. 1, in which the vehicle 100 is implemented as a pickup truck having a truck bed, is merely illustrative. In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a dashboard 20, one or more seats 50, and processing circuitry 108.

In one or more implementations, the seats 50 and/or processing circuitry 108 as described herein may also, or alternatively, be implemented in another apparatus, such as a building (e.g., a residential home or commercial building, or any other building) or other stationary apparatus.

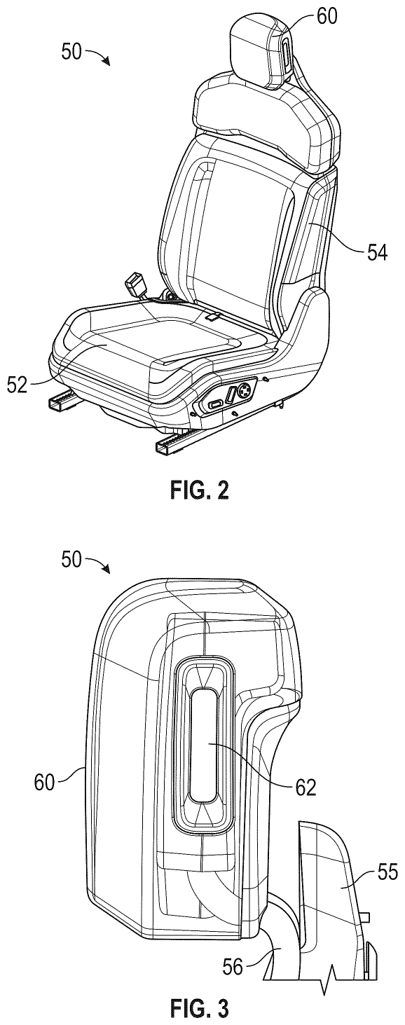

Referring now to FIGS. 2-5, one or more seats of the vehicle can provide an ability to releasably engage and remove a headrest. It will be understood that the features described herein with regard to an illustrative example of a seat can be applied to any one or more seats of a vehicle.

As shown in FIG. 2, a seat 50 can include a seat base 52, a seat back 54, and a headrest 60. The seat base 52 can form a portion upon which a user may be seated while operating or traveling in the vehicle. The seat base 52 can extend generally horizontally for supporting the user against the force of gravity. The seat back 54 can extend generally vertically in at least one configuration thereof for supporting the user against a force from forward acceleration of the vehicle. The headrest 60 can be positioned at an upper region of the seat back 54. The headrest 60 can support the user against a force from forward acceleration of the vehicle.

As shown in FIG. 3, the seat 50 can include one or more mechanisms for coupling the headrest 60 to the seat back. For example, the seat back can include one or more armatures 56 extending from an upper portion thereof. In some embodiments, the seat back can form a shield 55 that extends vertically alongside the armatures 56. The shield 55 can extend at least as far as the armatures 56, such that the shield 55 defined a farthest extent of the seat back. As further shown in FIG. 3, the headrest 60 can include a release button 62. The release button 62 can be provided on a lateral side of the headrest 60. For example, the release button 62 can on a side of the headrest 60 that faces a corresponding door of the vehicle.

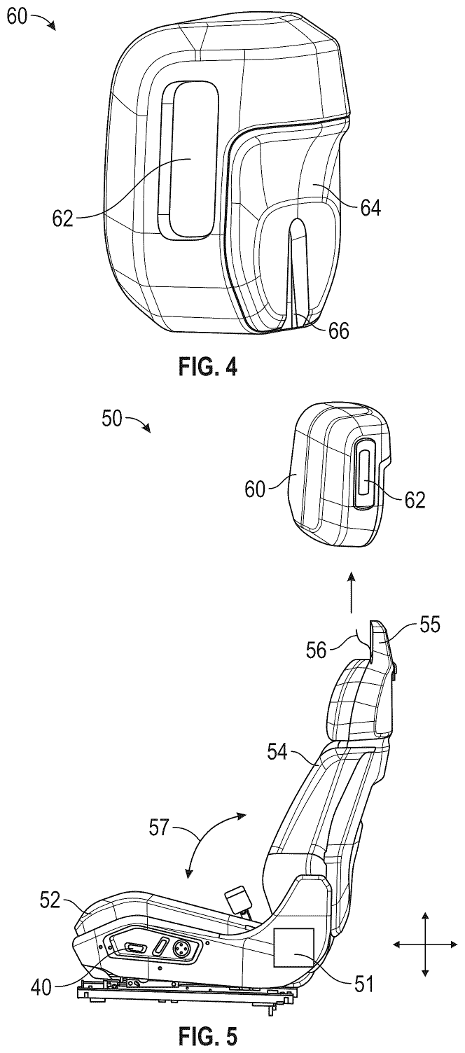

As shown in FIG. 4, a headrest 60 can include a recessed portion 64 that is configured to face and receive a portion of a shield of a seat back. The recessed portion 64 can be on a rear side of the headrest 60. The headrest 60 can further define one or more openings 66 for receiving the armatures of the seat back. The headrest 60 can include one or more mechanisms within the opening 66 for engaging the armatures, as described further herein.

As shown in FIG. 5, the headrest 60 can be removed from the seat back 54. In some embodiments, the release button 62 of the headrest 60 can be actuated to facilitate and/or otherwise allow removal of the headrest 60. While or after the release button 62 is actuated, the headrest 60 can be removed from the armatures 56.

In some embodiments, one or more portions of the seat 50 can be moved with respect to the other portions and/or other features of the vehicle. In some embodiments, the seat 50 can be adjusted translationally and/or rotationally. For example, the seat base 52 can be configured to move within one or more axes and/or rotate about one or more axes. By further example, the seat back 54 can be configured to move within one or more axes and/or rotate about one or more axes. The seat back 54 can form an angle 57 with respect to the seat base 52 and/or a floor of the vehicle. The seat back 54 can be adjustable within a range of angles 57, such as 0-180 degrees. The seat 50 can include or be coupled to one or more actuators 51 that facilitate such adjustments. An actuator 51 may include one or more devices for directly or indirectly moving and/or controlling the seat 50 and/or components thereof. The actuator 51 may be one or more types of actuators such as an electric, magnetic, mechanical, or any other type of actuator. The actuator 51 can include motors, hydraulic actuators, pneumatic actuators, magnetic actuators, piezoelectric actuators, electroactive materials, stepper motors, shape-memory alloys, and the like, as well as drivetrain components such as gears, clutches, and/or transmissions, to facilitate movement of the seat 50 and/or its components based on operation of the actuator 51.

In some embodiments, the seat 50 can include an input device 40 for receiving user inputs. Such user inputs can include generate signals that include instructions to adjust one or more features of the seat 50. The input device 40 can be provided at the seat 50 and/or any location of the vehicle. An input device 40 can be operated to initiate transition or one, more than one, or all of the seats. Accordingly, a single input can be provide cause transition of multiple seats 50.

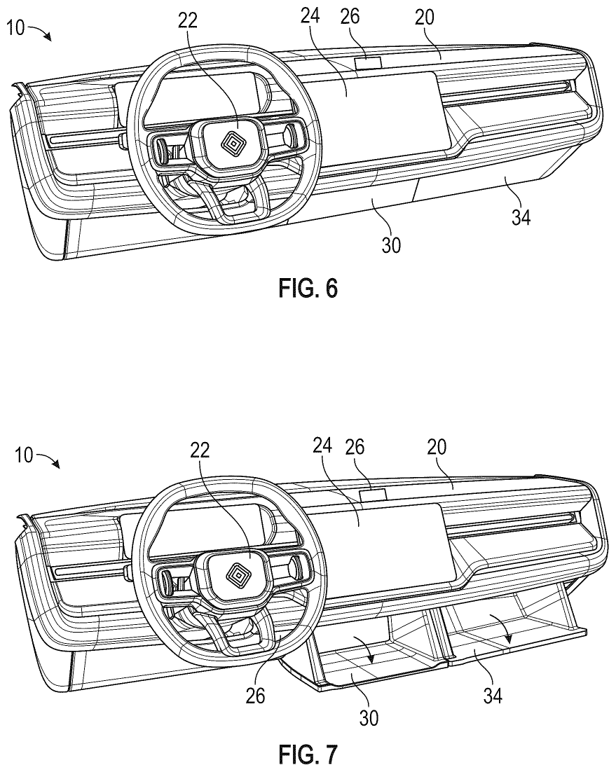

Referring now to FIGS. 6 and 7, a container system 10 can be located within a passenger compartment of a vehicle. As shown in FIG. 6, the vehicle can include a dashboard 20 that includes and/or supports one or more components, such as a steering wheel 22 and/or a display device 24 configured to detect a user input. In some embodiments, the display device 24 and/or one or more other user interface devices can provide an ability to receive inputs from a user. In some embodiments, the display device 24 and/or one or more other user interface devices can provide an ability to provide outputs to a user.

As shown in FIG. 6, the dashboard 20 and/or another portion of the vehicle can include a sensor 26. The sensor 26 can be operated to detect one or more conditions within the passenger compartment. For example, the sensor 26 can detect a condition of a seat, a headrest, a user, and/or one or more other conditions with respect to the vehicle. In some embodiments, the sensor 26 can include a camera, optical sensor, depth sensor, proximity sensor, and the like. In some embodiments, the sensor 26 can be integrated within a component with respect to which the sensor 26 is operated to detect a condition. For example, the sensor 26 can be integrated within a seat for detections related to the seat, as described further herein.

In some embodiments, one or more containers 30 and 34 can be located along a dashboard 20 of the vehicle. For example, one or more containers 30 and 34 can be positioned at one or more sides of and/or beneath a steering wheel 22 and/or a display device 24 at the dashboard 20. In some embodiments, the one or more containers 30 and 34 can be aligned along a common side (e.g., underside) of the dashboard 20. In some embodiments, separate containers 30 and 34 can be positioned adjacent to each other.

As shown in FIG. 7, the dashboard 20 can define one or more recesses for receiving the containers 30 and 34. Each of the containers 30 and 34 can transition between a closed configuration (FIG. 6) (e.g., within the recesses of the dashboard 20) and an open configuration (FIG. 7) (e.g., extending away from the dashboard 20). The seats of the vehicle (not shown) can facilitate transition of the containers between the open configuration and the closed configuration, as described further herein.

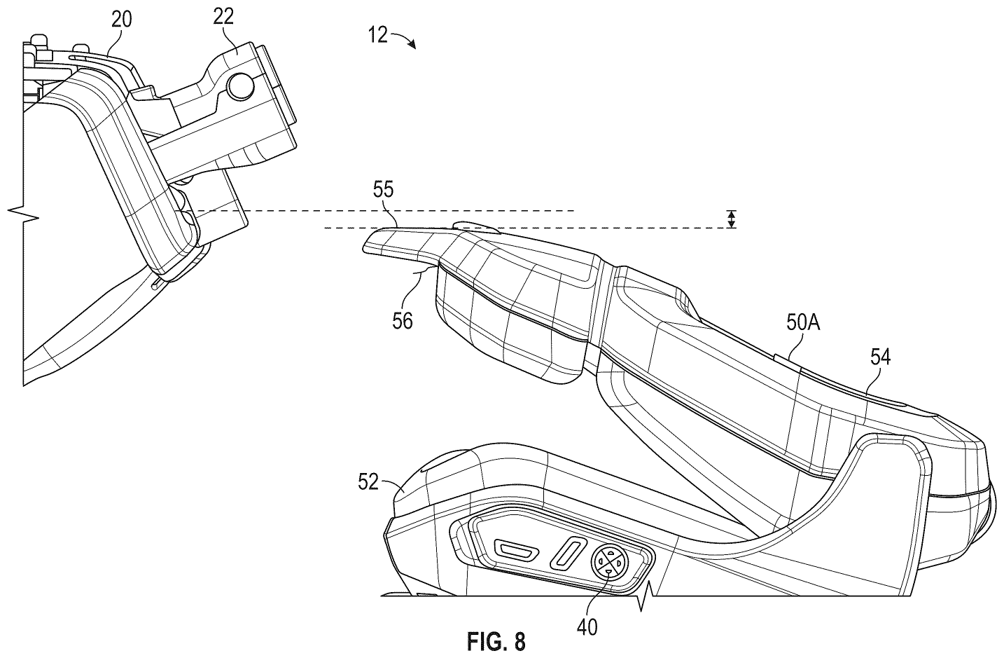

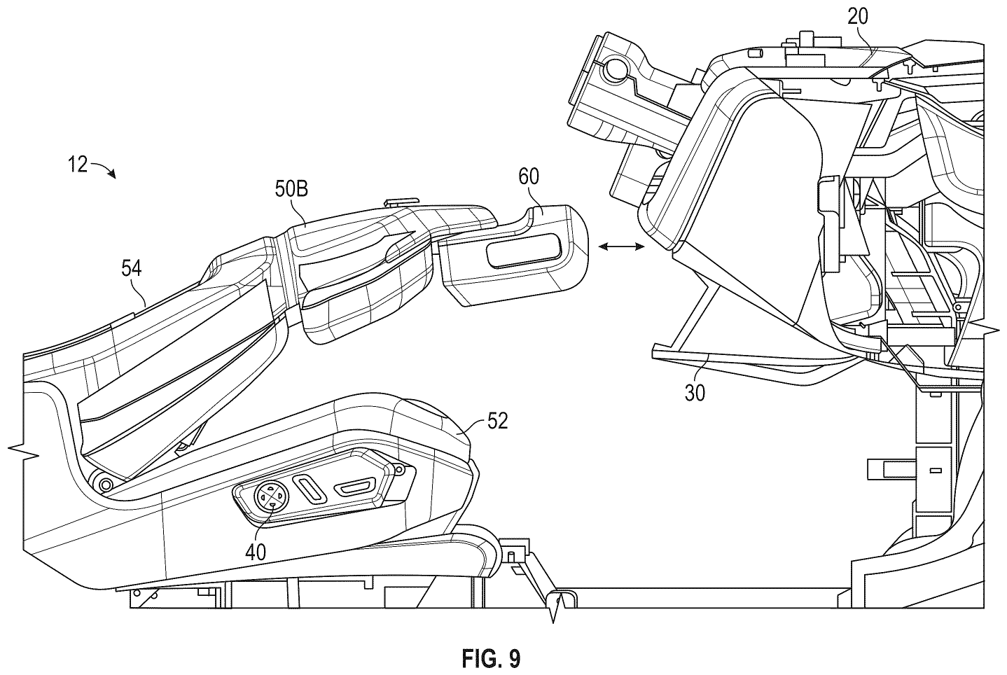

Referring now to FIGS. 8 and 9, a headrest of one or more seats can be removed to facilitate transitions and/or adjustments of the one or more seats. As shown in FIG. 8, the headrest (not shown) can be removed from the seat back 54 of a first seat 50A. In the depicted example, the first seat 50A can be a driver seat that is aligned with the steering wheel 22 extending from the dashboard 20. Removal of the headrest can leave the shield 55 and/or the armatures 56 of the seat back 54 defining an uppermost extent of the seat back 54. As such, the overall height of the seat back 54 is reduced following removal of the headrest. Accordingly, the seat back 54 is provided with greater clearance with respect to the steering wheel 22 and/or other components of the dashboard 20. In such a configuration, the transition of the seat back 54 to a folded configuration is enhanced by providing clearance with respect to other structures of the vehicle. It will be understood that such adjustments from an extended configuration to the folded the configuration can include other adjustments to the first seat 50A, such as a change in the position and/or orientation of the seat base 52 (e.g., away from the steering wheel 22 and/or other components of the dashboard 20).

As shown in FIG. 9, the headrest 60 can remain attached to the seat back 54 of a second seat 50B. Where such a second seat 50B is at another location, the dashboard 20 can provide adequate clearance even when the headrest 60 remains attached to the seat back 54. As such, the second seat 50B can undergo transitions to the folded configuration without requiring removal of the headrest 60. It will be understood that such adjustments from an extended configuration to the folded the configuration can include other adjustments to the seat 50B, such as a change in the position and/or orientation of the seat base 52 (e.g., away from the dashboard 20).

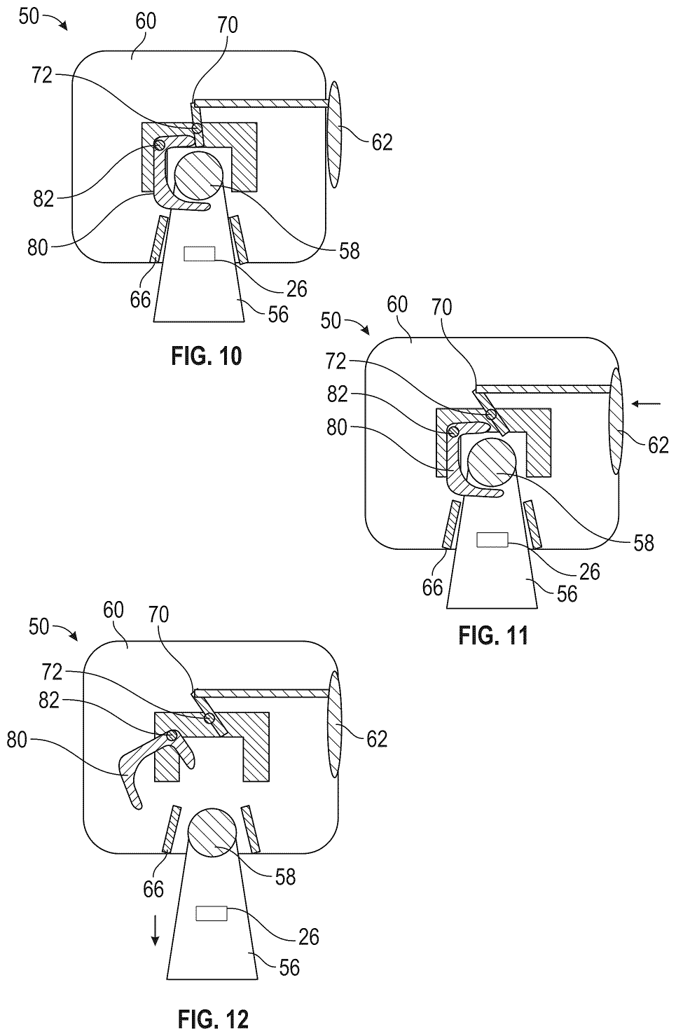

Referring now to FIGS. 10-12, a headrest can provide one or more locking mechanisms for releasably securing to armatures of a seat back. As shown in FIG. 10, a seat 50 can include a headrest 60 that is releasably attachable to one or more armatures 56 extending from a seat back (not shown). The one or more armatures 56 can include a striker 58, for example at a terminal end thereof. The striker 58 can be received within an opening 66 of the headrest 60. In a locked configuration, a latch 80 of the headrest 60 can engage the striker 58, for example to prevent removal thereof from the opening 66 until release of the latch 80. For example, at least a portion of the latch 80 can be interposed between the striker 58 and the opening 66, such that removal of the latch 80 from such a location is required before the striker 58 can be removed from the opening 66. In some embodiments, the latch 80 can be maintained in the locked configuration by one or more mechanisms, such as a lever 70. The release button 62 of the headrest 60 can be operable (e.g., by a user) to actuate the lever 70 and/or the latch 80. In some embodiments, the latch 80 can be biased to move away from the striker 58 but can be retained in a locked configuration by the lever 70.

As shown in FIG. 11, the release button 62 can be actuated, for example by a force applied by a user. Actuation of the release button 62 can result in actuation of the lever 70. In some embodiments, the lever 70 can rotate about a lever pivot 72. Additionally or alternatively, the lever 70 can move translationally. By actuating the lever 70, the lever 70 can be moved with respect to (e.g., away from) the latch 80. In some embodiments, the seat 50 can include a sensor 26. The sensor can be located at the seat back (e.g., at the one or more armatures 56) and/or at the headrest 60. The sensor 26 can be operated to detect a condition of the seat 50, the headrest 60, a user, and/or one or more other conditions with respect to the vehicle. In some embodiments, the sensor 26 can include a camera, optical sensor, depth sensor, proximity sensor, and the like. In some embodiments, the sensor 26 can be operated to detect whether the headrest 60 is attached to the seat back (e.g., at the one or more armatures 56). For example, the sensor 26 can be located at the one or more armatures 56 and detect the presence and/or engagement of one or more components of the headrest 60. By further example, the sensor 26 can be located at the headrest 60 and detect the presence and/or engagement of one or more components of the seat back (e.g., one or more armatures 56).

As shown in FIG. 12, as the lever 70 is moved with respect to (e.g., away from) the latch 80, the latch 80 can be permitted to move with respect to the striker 58. In some embodiments, the latch 80 can rotate about a latch pivot 82. Additionally or alternatively, the latch 80 can move translationally. In some embodiments, the latch 80 can be biased to move away from the striker 58, and removal of the lever 70 can allow the latch 80 to move to the unlocked configuration thereof. With the latch 80 in the unlocked configuration, the striker 58 can be permitted to pass out of the opening 66, which can further allow the headrest 60 to be released and removed from the armatures 56. Where the latch 80 is biased to the unlocked configuration, the latch 80 can be maintained in the unlocked configuration even when the user input (e.g., force) is removed from the release button 62.

In some embodiments, as shown in FIGS. 10-12, the seat 50 includes a linkage of parts in an assembly that includes the release button 62, the lever 70, and/or the latch 80, such that physical actuation of the release button 62 (e.g., by a user) causes and/or otherwise results in physical actuation of the lever 70 and/or the latch 80. It should be understood that one or more other types of inputs can cause and/or otherwise result in physical actuation of the lever 70 and/or the latch 80, for example via one or more intermediate mechanisms. In some embodiments, the release button 62 can be an actively operated input device, such as an electromechanical switch, an electrical button, a touchscreen, and the like. A user input at the release button 62 can activate one or more mechanisms for controlling and/or effecting physical actuation of the lever 70 and/or the latch 80. In some embodiments, the seat 50 includes one or more motors that can be operated to actuate the lever 70 and/or the latch 80 in response to a user input at the release button 62. In some embodiments, the seat 50 includes one or more shape memory alloys (e.g., at the lever 70 and/or the latch 80) and a thermal output device (e.g., heater, etc.) that is operable to control a temperature of the one or more shape memory alloys and correspondingly actuate the lever 70 and/or the latch 80 in response to a user input at the release button 62. In some embodiments, the seat 50 includes one or more magnets (e.g., at the lever 70 and/or the latch 80) and one or more solenoids and/or other magnetic field generators that are operable to influence the one or more magnets and correspondingly actuate the lever 70 and/or the latch 80 in response to a user input at the release button 62.

The headrest can be secured to the armatures 56 by inserting the striker 58 into the opening until it reaches the latch 80. Further advancement can cause the striker 58 to actuate the latch 80 to the locked configuration (FIG. 10). In the absence of a user input (e.g., force) at the release button 62, the latch 80 can be maintained in the locked configuration (e.g., by the lever 70).

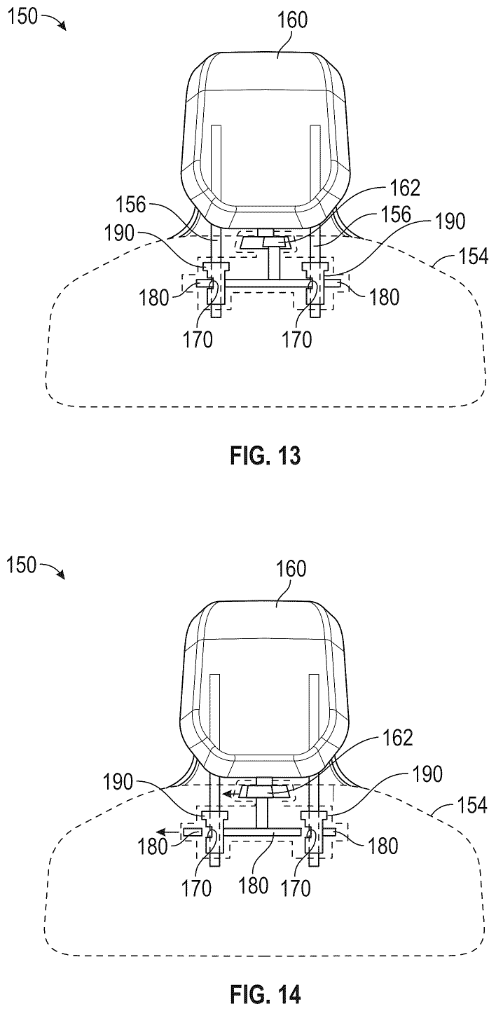

Referring now to FIGS. 13-15, a seat back can provide one or more locking mechanisms for releasably securing to armatures of a headrest. As shown in FIG. 13, a seat 150 can include a headrest 160 that includes and/or is connected or attachable to one or more armatures 156 extending from a body thereof. The one or more armatures 156 can include a striker 170 (e.g., a notch, indentation, ledge, shoulder, recess, detent, protrusion, hook, pin, and/or combinations thereof). The armatures 156 can be received within respective housings 190 of the seat back 154, for example within openings or channels thereof. The housings 190 can be accessible from an exterior of the seat back 154 while being at and/or recessed within an outer periphery of a body of the seat back 154. The armatures 156 can be inserted until the strikers 170 are aligned with respective latches 180 of the seat back 154. In a locked configuration, the latches 180 of the seat back 154 can engage the respective strikers 170, for example to prevent removal thereof from the housings 190 until release of the latch 180. For example, at least a portion of each latch 180 can be interposed between the respective striker 170 and a respective entry of the housings 190, such that removal of the latch 180 from such a location (e.g., at the strikers 170) is required before the armatures 156 (e.g., including the strikers 170) can be removed from the housings 190. In some embodiments, the latch 180 can be maintained in the locked configuration by one or more mechanisms, such as a spring bias (not shown). The release button 162 of the seat back 154 can be operable (e.g., by a user) to actuate the latches 180.

In some embodiments, the seat 150 can include a sensor (not shown), such as the sensor 26 of FIGS. 10-12. The sensor can be located at the seat back 154 (e.g., at the one or more armatures 156) and/or at the headrest 160. The sensor can be operated to detect a condition of the seat 150, the headrest 160, a user, and/or one or more other conditions with respect to the vehicle. In some embodiments, the sensor can include a camera, optical sensor, depth sensor, proximity sensor, and the like. In some embodiments, the sensor can be operated to detect whether the headrest 160 is attached to the seat back 154 (e.g., at the one or more armatures 156).

As shown in FIG. 14, the release button 162 can be actuated, for example by a force applied by a user. Actuation of the release button 162 can result in actuation of the latches 180. In some embodiments, the latches 180 can translate along with the release button 162. Additionally or alternatively, the latches 180 can move rotationally and/or translationally in a manner that is different from the movement of the release button 162. By actuating the latches 180, the latches 180 can be moved with respect to (e.g., away from) the strikers 170.

In some embodiments, as shown in FIG. 14, the seat 150 includes a linkage of parts in an assembly that includes the latches 180 and the release button 162, such that physical actuation of the release button 162 (e.g., by a user) causes and/or otherwise results in physical actuation of the one or more latches 180. It should be understood that one or more other types of inputs can cause and/or otherwise result in physical actuation of the one or more latches 180, for example via one or more intermediate mechanisms. In some embodiments, the release button 162 can be an actively operated input device, such as an electromechanical switch, an electrical button, a touchscreen, and the like. A user input at the release button 162 can activate one or more mechanisms for controlling and/or effecting physical actuation of the one or more latches 180. In some embodiments, the seat 150 includes one or more motors that can be operated to actuate the one or more latches 180 in response to a user input at the release button 162. In some embodiments, the seat 150 includes one or more shape memory alloys (e.g., at the one or more latches 180) and a thermal output device (e.g., heater, etc.) that is operable to control a temperature of the one or more shape memory alloys and correspondingly actuate the one or more latches 180 in response to a user input at the release button 162. In some embodiments, the seat 150 includes one or more magnets (e.g., at the one or more latches 180) and one or more solenoids and/or other magnetic field generators that are operable to influence the one or more magnets and correspondingly actuate the one or more latches 180 in response to a user input at the release button 162.

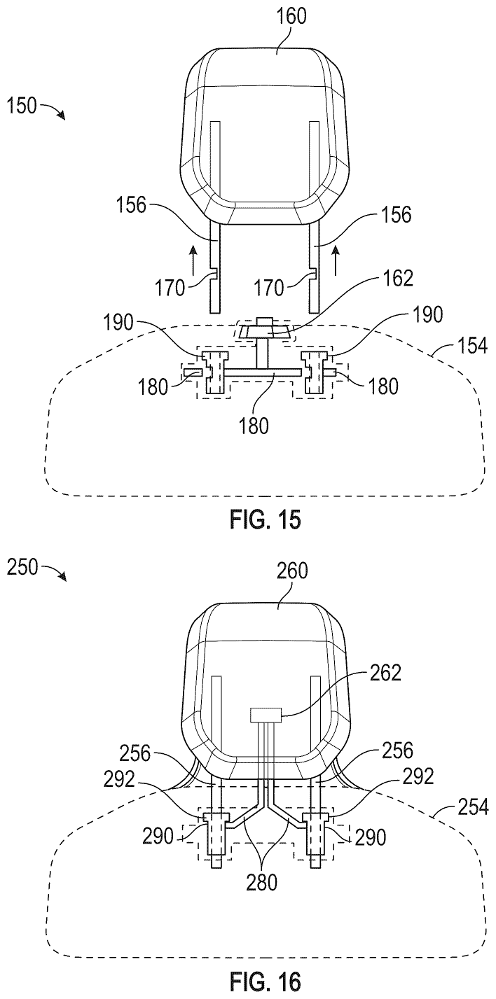

As shown in FIG. 15, as the latches 180 are moved with respect to (e.g., away from) the strikers 170, the headrest 160 (e.g., including the armatures 156) can be permitted to move with respect to the seat back 154. For example, with the latches 180 in the unlocked configuration, the armatures 156 can be permitted to pass out of the housings 190, which can further allow the headrest 160 to be released and removed from the seat back 154.

The headrest 160 can be stored (e.g., along with the armatures 156) in another location, such as a glove box. The headrest 160 can be secured again to the seat back 154 by inserting the armatures 156 into the respective housings 190. Inserting the armatures 156 can result in the strikers 170 coming into alignment and engagement with the latches 180. In the absence of a user input (e.g., force) at the release button 162, the latches 180 can be maintained in the locked configuration to retain the headrest 160 with respect to the seat back 154.

Referring now to FIGS. 16-18, a headrest can provide one or more locking mechanisms for releasably securing to a headrest. As shown in FIG. 16, a seat 250 can include a headrest 260 that includes and/or is connected or attachable to one or more armatures 256 extending from a body thereof. The armatures 256 can be received within respective housings 290 of the seat back 254, for example within openings or channels thereof. The housings 290 can be accessible from an exterior of the seat back 254 while being at and/or recessed within an outer periphery of a body of the seat back 254. The housings 290 can each include a striker 292 (e.g., a notch, indentation, ledge, shoulder, recess, detent, protrusion, hook, pin, and/or combinations thereof). The armatures 256 can be inserted until the latches 280 of the headrest 260 are aligned with respective strikers 292 of the seat back 254. In a locked configuration, the latches 280 of the headrest 260 can engage the respective strikers 292, for example to prevent removal of the armatures 256 from the housings 290 until release of the latches 280. For example, at least a portion of each striker 292 can be interposed between the respective latch 280 and a respective entry of the housings 290, such that removal of the latch 280 from such a location (e.g., at the strikers 292) is required before the armatures 256 can be removed from the housings 290. In some embodiments, the latch 280 can be maintained in the locked configuration by one or more mechanisms, such as a spring bias (not shown). The release button 262 of the headrest 260 can be operable (e.g., by a user) to actuate the latches 280. In some embodiments, the release button of the headrest 260 can be connected to the latches 280, which can extend to the seat back 254 (e.g., at least to the strikers 292). Accordingly, engagement can occur within the seat back 254 while release control can be provided at the headrest 260.

In some embodiments, the seat 250 can include a sensor (not shown), such as the sensor 26 of FIGS. 10-12. The sensor can be located at the seat back 254 (e.g., at the one or more armatures 256) and/or at the headrest 260. The sensor can be operated to detect a condition of the seat 250, the headrest 260, a user, and/or one or more other conditions with respect to the vehicle. In some embodiments, the sensor can include a camera, optical sensor, depth sensor, proximity sensor, and the like. In some embodiments, the sensor can be operated to detect whether the headrest 260 is attached to the seat back 254 (e.g., at the one or more armatures 256).

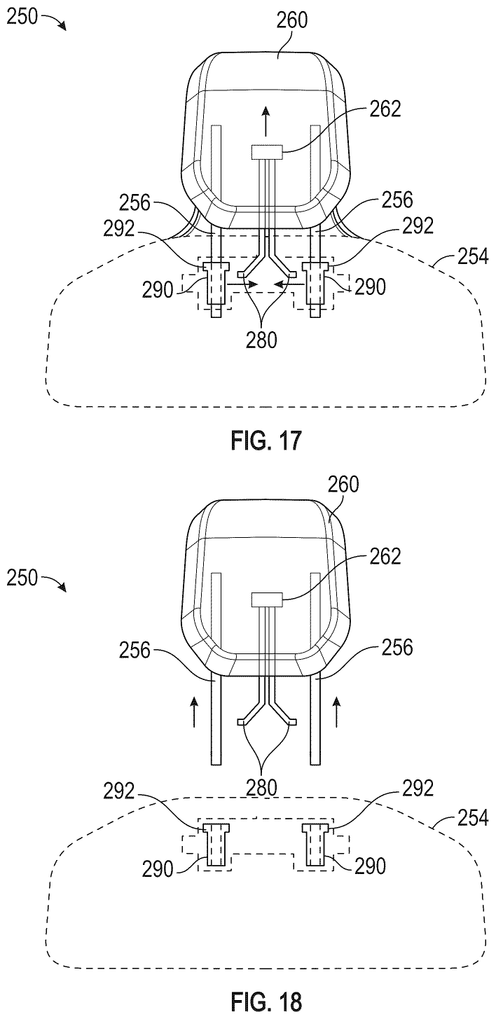

As shown in FIG. 17, the release button 262 can be actuated, for example by a force applied by a user. Actuation of the release button 262 can result in actuation of the latches 280. In some embodiments, the latches 280 can translate along with the release button 262. Additionally or alternatively, the latches 280 can move rotationally and/or translationally in a manner that is different from the movement of the release button 262. For example, as shown in FIG. 16, the release button 262 can be moved in a first direction (e.g., away from the seat back 254), and the latches 280 can be moved in one or more other directions, different from the first direction. By further example, by actuating the latches 280, the latches 280 can be moved with respect to (e.g., away from) the strikers 292 (e.g., towards each other as shown in FIG. 17).

In some embodiments, as shown in FIG. 17, the seat 250 includes a linkage of parts in an assembly that includes the latches 280 and the release button 262, such that physical actuation of the release button 262 (e.g., by a user) causes and/or otherwise results in physical actuation of the one or more latches 280. It should be understood that one or more other types of inputs can cause and/or otherwise result in physical actuation of the one or more latches 280, for example via one or more intermediate mechanisms. In some embodiments, the release button 262 can be an actively operated input device, such as an electromechanical switch, an electrical button, a touchscreen, and the like. A user input at the release button 262 can activate one or more mechanisms for controlling and/or effecting physical actuation of the one or more latches 280. In some embodiments, the seat 250 includes one or more motors that can be operated to actuate the one or more latches 280 in response to a user input at the release button 262. In some embodiments, the seat 250 includes one or more shape memory alloys (e.g., at the one or more latches 280) and a thermal output device (e.g., heater, etc.) that is operable to control a temperature of the one or more shape memory alloys and correspondingly actuate the one or more latches 280 in response to a user input at the release button 262. In some embodiments, the seat 250 includes one or more magnets (e.g., at the one or more latches 280) and one or more solenoids and/or other magnetic field generators that are operable to influence the one or more magnets and correspondingly actuate the one or more latches 280 in response to a user input at the release button 262.

As shown in FIG. 18, as the latches 280 are moved with respect to (e.g., away from) the strikers 292, the headrest 260 (e.g., including the armatures 256) can be permitted to move with respect to the seat back 254. For example, with the latches 280 in the unlocked configuration, the armatures 256 can be permitted to pass out of the housings 290, which can further allow the headrest 260 to be released and removed from the seat back 254.

The headrest 260 can be stored (e.g., along with the armatures 256) in another location, such as a glove box. The headrest 260 can be secured again to the seat back 254 by inserting the armatures 256 into the respective housings 290. Inserting the armatures 256 can result in the strikers 292 coming into alignment and engagement with the latches 280. In the absence of a user input (e.g., force) at the release button 262, the latches 280 can be maintained in the locked configuration to retain the headrest 260 with respect to the seat back 254.

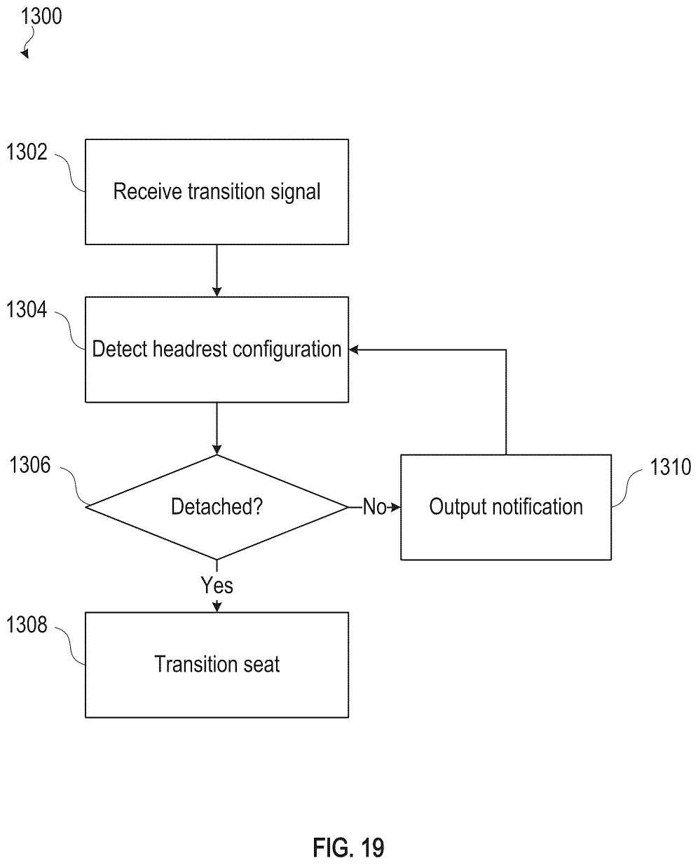

FIG. 19 illustrates a flow diagram of an example process 1300 for managing transition of a seat in response to a user input in accordance with one or more implementations of the subject technology. For explanatory purposes, the process 1300 is primarily described herein with reference to the vehicle 100, seat 50, headrest 60, seat 150, headrest 160, seat 250, and/or headrest 260 of FIGS. 1-18, and/or various components thereof. However, the process 1300 is not limited to the vehicle 100, seat 50, headrest 60, seat 150, headrest 160, seat 250, and/or headrest 260 of FIGS. 1-18, and one or more blocks (or operations) of the process 1300 may be performed by one or more other structural components of the vehicle 100 and/or of other suitable moveable apparatuses, devices, or systems. Further, for explanatory purposes, some of the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

At block 1302, the vehicle can receive a transition signal comprising an instruction to transition a seat. For example, the transition signal can include an instruction to transition a seat from an extended configuration to a folded configuration. The transition signal can be provided by a user via an input device, such as a control on a portion of the seat, a display device, and/or another user interface device (e.g., at an interior region and/or an exterior region of the vehicle). In some embodiments, the transition signal includes an instruction to transition multiple seats (e.g., all seats of the vehicle and/or a row or other portion of the vehicle) to a folded configuration. Accordingly, the configuration of multiple seats can be modified and/or otherwise controlled in response to a single input. In some embodiments, the transition signal is generated in response to user input (e.g., at an input device). In some embodiments, the transition signal is generated in response to a user input at a seat. In some embodiments, the transition signal is generated in response to a user input at another portion of the vehicle, such as a liftgate. In some embodiments, the transition signal is generated in response to a detected configuration (e.g., open or closed) of another portion of the vehicle, such as a liftgate.

At block 1304, the vehicle can detect a headrest configuration. For example, the vehicle can detect whether a headrest is attached to a seat back of the seat or detached from the seat back. In some embodiments, the vehicle can detect the configuration of the headrest by operating a sensor, such as a camera providing a field of view that includes a seat. In some embodiments, the vehicle can detect the configuration of the headrest by operating a sensor at an interface between the headrest and the seat back. In some embodiments, headrest detection can be limited to those seats for which removal of the headrest is required to complete the transition (e.g., the seat of FIG. 8, rather than the seat of FIG. 9). In some embodiments, where headrest removal is not required to complete the transition, headrest detection can be omitted and transitions can be performed based on whether or not headrests are present for seats for which removal is required.

At block 1306, if the vehicle detects that the headrest is detached from (e.g., is not attached to) the seat back, the process 1300 can proceed to block 1308. If the vehicle detects that the headrest is not detached from (e.g., is attached to) the seat back, the process 1300 can proceed to block 1310.

At block 1308, the vehicle can transition the seat from the extended configuration to folded configuration. For example, upon detecting that the headrest is detached from the seat back, the vehicle can determine that adequate clearance is provided to transition the seat. In some embodiments, the vehicle can adjust the seat in one or more other ways. For example, the vehicle can adjust the position and/or orientation of one or more portions of the seat. It will be understood that such operations can be provided in series or in parallel.

Following block 1308, the process 1300 can return to block 1302 and/or another block and/or process.

At block 1310, the vehicle can forgo transition of the seat and/or can output a notification. For example, the vehicle can output a notification via a display device, a speaker, and/or one or more other user interface devices of the vehicle. In some embodiments, the notification can include an instruction to remove the headrest. Following block 1310, the process 1300 can return to block 1304 and/or another block and/or process.

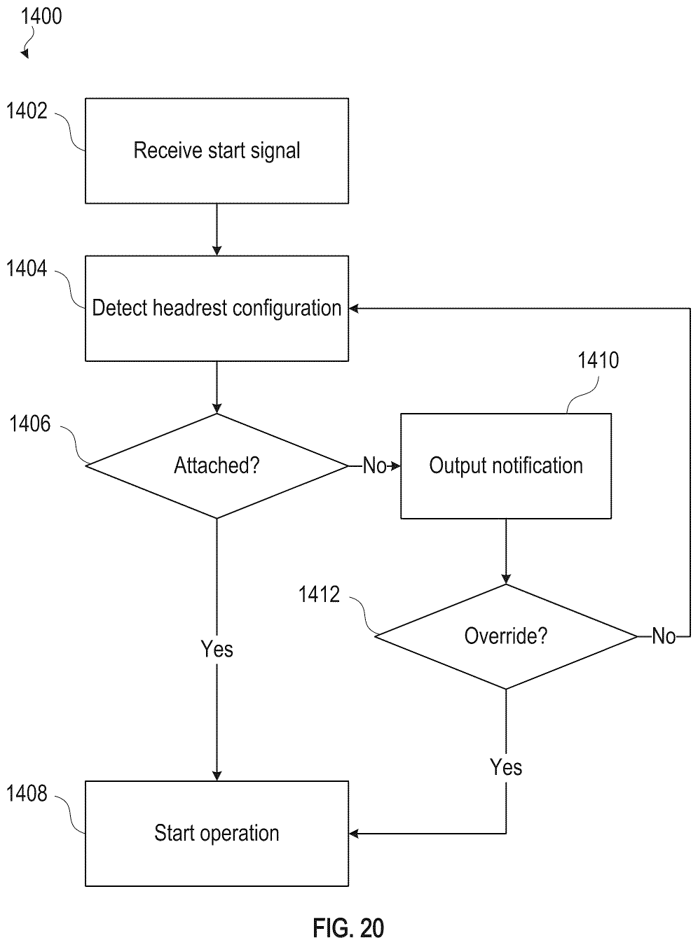

FIG. 20 illustrates a flow diagram of an example process 1400 for managing an operation in response to a user input in accordance with one or more implementations of the subject technology. For explanatory purposes, the process 1400 is primarily described herein with reference to the vehicle 100, seat 50, headrest 60, seat 150, headrest 160, seat 250, and/or headrest 260 of FIGS. 1-18, and/or various components thereof. However, the process 1400 is not limited to the vehicle 100, seat 50, headrest 60, seat 150, headrest 160, seat 250, and/or headrest 260 of FIGS. 1-18, and one or more blocks (or operations) of the process 1400 may be performed by one or more other structural components of the vehicle 100 and/or of other suitable moveable apparatuses, devices, or systems. Further, for explanatory purposes, some of the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

At block 1402, the vehicle can receive a start signal comprising an instruction to start an operation. For example, the start signal can include an instruction to transition a seat from an extended configuration to a folded configuration. The start signal can be provided by a user via an input device, such as a start/stop button, a steering wheel, a pedal, a display device, and/or another user interface device.

At block 1404, the vehicle can detect a headrest configuration. For example, the vehicle can detect whether a headrest is attached to a seat back of the seat or detached from the seat back. In some embodiments, the vehicle can detect the configuration of the headrest by operating a sensor, such as a camera providing a field of view that includes a seat. In some embodiments, the vehicle can detect the configuration of the headrest by operating a sensor at an interface between the headrest and the seat back. In some embodiments, headrest detection can be limited to those seats at which a user is present (e.g., headrest detection is preceded by user detection). In some embodiments, where no user is present, headrest detection can be omitted and operations can be performed based on whether or not headrests are present for seats containing users.

At block 1406, if the vehicle detects that the headrest is attached to (e.g., is not detached from) the seat back, the process 1400 can proceed to block 1408. If the vehicle detects that the headrest is not attached to (e.g., is detached from) the seat back, the process 1400 can proceed to block 1410.

At block 1408, the vehicle can perform one or more operations corresponding to the start signal. For example, upon detecting that the headrest is attached to the seat back, the vehicle can operate a motor of the vehicle and/or allow operation of a steering wheels and/or pedals of the vehicle.

Following block 1408, the process 1400 can return to block 1402 and/or another block and/or process.

At block 1410, the vehicle can forgo performance of the operation and/or output a notification. For example, the vehicle can output a notification via a display device, a speaker, and/or one or more other user interface devices of the vehicle. In some embodiments, the notification can include an instruction to install the headrest. Following block 1410, the process 1400 can return to block 1404 and/or another block and/or process.

In some embodiments, the vehicle can receive an override signal comprising an instruction to perform the operation even if the headrest is not attached to (e.g., is detached from) the seat back. The override signal can be provided by a user via an input device, such as a start/stop button, a steering wheel, a pedal, a display device, and/or another user interface device. At block 1412, if the vehicle does not receive the override signal, the process 1400 can proceed to block 1408. If the vehicle receives the override signal, the process 1400 can return to block 1404 and/or another block and/or process.

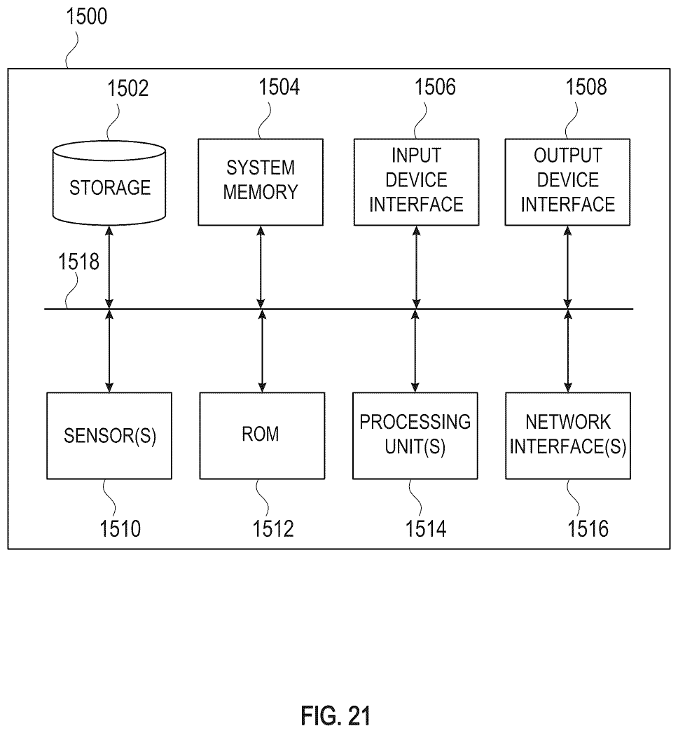

FIG. 21 illustrates an example electronic system 1500 with which aspects of the present disclosure may be implemented. The electronic system 1500 can be, and/or can be a part of, any electronic device for providing the features and performing processes described in reference to FIGS. 1-14, including but not limited to a vehicle, computer, server, smartphone, and wearable device (e.g., authentication device). The electronic system 1500 may include various types of computer-readable media and interfaces for various other types of computer-readable media. The electronic system 1500 includes a persistent storage device 1502, system memory 1504 (and/or buffer), input device interface 1506, output device interface 1508, sensor(s) 1510, ROM 1512, processing unit(s) 1514, network interface 1516, bus 1518, and/or subsets and variations thereof.

The bus 1518 collectively represents all system, peripheral, and chipset buses that communicatively connect the numerous internal devices and/or components of the electronic system 1500, such as any of the components of the vehicle 100 discussed above with respect to FIG. 1. In one or more implementations, the bus 1518 communicatively connects the one or more processing unit(s) 1514 with the ROM 1512, the system memory 1504, and the persistent storage device 1502. From these various memory units, the one or more processing unit(s) 1514 retrieves instructions to execute and data to process in order to execute the processes of the subject disclosure. The one or more processing unit(s) 1514 can be a single processor or a multi-core processor in different implementations. In one or more implementations, one or more of the processing unit(s) 1514 may be included in a container system, such as in the form of the processing circuitry 108.

The ROM 1512 stores static data and instructions that are needed by the one or more processing unit(s) 1514 and other modules of the electronic system 1500. The persistent storage device 1502, on the other hand, may be a read-and-write memory device. The persistent storage device 1502 may be a non-volatile memory unit that stores instructions and data even when the electronic system 1500 is off. In one or more implementations, a mass-storage device (such as a magnetic or optical disk and its corresponding disk drive) may be used as the persistent storage device 1502.

In one or more implementations, a removable storage device (such as a floppy disk, flash drive, and its corresponding disk drive) may be used as the persistent storage device 1502. Like the persistent storage device 1502, the system memory 1504 may be a read-and-write memory device. However, unlike the persistent storage device 1502, the system memory 1504 may be a volatile read-and-write memory, such as RAM. The system memory 1504 may store any of the instructions and data that one or more processing unit(s) 1514 may need at runtime. In one or more implementations, the processes of the subject disclosure are stored in the system memory 1504, the persistent storage device 1502, and/or the ROM 1512. From these various memory units, the one or more processing unit(s) 1514 retrieves instructions to execute and data to process in order to execute the processes of one or more implementations.

The persistent storage device 1502 and/or the system memory 1504 may include one or more machine learning models. Machine learning models, such as those described herein, are often used to form predictions, solve problems, recognize objects in image data, and the like. For example, machine learning models described herein may be used to predict whether an authorized user is approaching a vehicle and intends to open a charging port closure. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 1518 also connects to the input device interfaces 1506 and output device interfaces 1508. The input device interface 1506 enables a user to communicate information and select commands to the electronic system 1500. Input devices that may be used with the input device interface 1506 may include, for example, alphanumeric keyboards, touch screens, and pointing devices. The output device interface 1508 may enable the electronic system 1500 to communicate information to users. For example, the output device interface 1508 may provide the display of images generated by electronic system 1500. Output devices that may be used with the output device interface 1508 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1518 also connects to sensor(s) 1510. The sensor(s) 1510 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 1510 may be utilized to detect movement, travel, and orientation of the electronic system 1500. For example, the sensor(s) may include an accelerometer, a rate gyroscope, and/or other motion-based sensor(s). The sensor(s) 1510 may include one or more biometric sensors and/or image sensors for authenticating a user.

The bus 1518 also couples the electronic system 1500 to one or more networks and/or to one or more network nodes through the one or more network interface(s) 1516. In this manner, the electronic system 1500 can be a part of a network of computers (such as a local area network or a wide area network). Any or all components of the electronic system 1500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a seat back;
an armature extending from a portion of the seat back and comprising a striker;
a headrest configured to receive a portion of the armature and comprising:
a latch configured to releasably engage the striker; and
a release button configured to actuate the latch to release the striker; and
a sensor configured to detect whether the headrest is attached to the seat back.

2. The apparatus of claim 1, wherein the latch is configured to rotate within the headrest to transition between a locked configuration and an unlocked configuration.

3. The apparatus of claim 2, wherein the latch is biased to the unlocked configuration.

4. The apparatus of claim 3, wherein the headrest further comprises a lever configured to maintain the latch in the locked configuration while the lever is in a first configuration, wherein the release button is configured to actuate the latch by transitioning the lever to a second configuration, in which the lever is configured to allow the latch to transition to the unlocked configuration.

5. The apparatus of claim 1, wherein the release button defines a portion of an outer periphery of the headrest.

6. The apparatus of claim 1, wherein the portion of the armature is a first portion of the armature, wherein the seat back is configured to receive a second portion of the armature.

7. The apparatus of claim 1, wherein a portion of the latch extends from the headrest to within a portion of the seat back to releasably engage the striker.

8. A method comprising:
receiving a transition signal comprising an instruction to transition a seat from an extended configuration to a folded configuration; and
in response to receiving the transition signal:
detecting a configuration of a headrest of the seat;
in accordance with a determination that the headrest is attached to the seat, outputting a notification; and
in accordance with a determination that the headrest is detached from the seat, transitioning the seat from the extended configuration to the folded configuration.

9. The method of claim 8, further comprising, after outputting the notification:
detecting the configuration of the headrest of the seat;
in accordance with the determination that the headrest is attached to the seat, maintaining output of the notification; and
in accordance with the determination that the headrest is detached from the seat, ceasing output of the notification and transitioning the seat from the extended configuration to the folded configuration.

10. The method of claim 8, further comprising, in response to receiving the transition signal and in accordance with the determination that the headrest is attached to the seat, forgoing transition of the seat from the extended configuration to the folded configuration.

11. The method of claim 8, wherein detecting the configuration of the headrest of the seat comprises operating a camera to optically detect whether the headrest is attached to the seat.

12. The method of claim 8, wherein the notification includes an instruction to a user to detach the headrest from the seat.

13. The method of claim 8, wherein the transition signal is generated in response to a user input at an input device of the seat.

14. A method comprising:
receiving a start signal comprising an instruction to perform an operation of a vehicle; and
in response to receiving the start signal:
detecting a configuration of a headrest of a seat of the vehicle;
in accordance with a determination that the headrest is attached to the seat, performing the operation of the vehicle; and
in accordance with a determination that the headrest is detached from the seat, forgoing performance of the operation of the vehicle.

15. The method of claim 14, further comprising, in response to receiving the start signal and in accordance with the determination that the headrest is detached from the seat, outputting a notification.

16. The method of claim 15, further comprising:
after outputting the notification and while forgoing performance of the operation of the vehicle, receiving an override signal from a user; and
in response to receiving the override signal from the user, performing the operation.

17. The method of claim 16, wherein the override signal is generated in response to a user input at an input device of the vehicle.

18. The method of claim 15, wherein the notification includes an instruction to a user to attach the headrest to the seat.

19. The method of claim 14, wherein the operation comprises operating a motor of the vehicle.

20. The method of claim 14, wherein detecting the configuration of the headrest of the seat comprises operating a camera to optically detect whether the headrest is attached to the seat.
